(19) United States
(12) Patent Application Publication
(10) Pub. No.: US 2003/0167851 A1
(43) Pub. Date: Sep. 11, 2003

(54) Absolute micromachined silicon pressure sensor with backside hermetic cover and method of making the same

(76) Inventor: Gregory D. Parker, Charlotte, NC (US)

Correspondence Address: Honeywell International Inc, 101 Columbia Road, P.O. Box 2245, Morristown, NJ, 07962-2245, US

(21) Appl. No.: 10/354,160

(22) Filed: Jan. 30, 2003

Related U.S. Application Data
(60) Provisional application No. 60/352,278, filed on Jan. 30, 2002.

(51) Int. Cl. G01L 9/04

(52) U.S. Cl. 73/720; 73/726

(57) ABSTRACT

An absolute micromachined silicon pressure sensor provides the resistive or piezoresistive strain gauges, conductive traces, wirebond pads and other electrical components on a micromachined silicon die in a location that is isolated from the sensed fluid. This protects the electronic components from the corrosive effects of the sensed fluid. A hermetic cover is provided on the backside of the silicon die and is directly bonded thereto to create a hermetically sealed volume of gas or vacuum.

### RELATED APPLICATION

This application contains subject matter related to the subject matter disclosed in copending U.S. Provisional Patent Application Serial No. 60/352,278, filed on Jan. 30, 2002.

### FIELD OF THE INVENTION

The present invention relates to the field of pressure sensors, and more particularly to absolute pressure sensors that entrap a constant volume of air or a vacuum on one side of a diaphragm while exposing the other side of the diaphragm to a sensed fluid.

### BACKGROUND OF THE INVENTION

An absolute pressure sensor employs a sealed volume of gas or vacuum on one side of a diaphragm, with another side of the diaphragm being exposed to a sensed fluid. A typical absolute silicon pressure sensor is depicted in FIG. 1. The sensor 10 has a micromachined silicon die 12, typically 2×2 mm, that has been micromachined to form a diaphragm 14, typically 0.01 to 0.20 mm in thickness. Resistive or piezoresistive strain gauges 16 are implanted in the top of the silicon die 12 in the diaphragm 14. Conductive traces 18 connect the strain gauges 16 to wirebond pads 20 that connect to the sensor electronics.

Ceramic, glass, or other hermetic material 22 is connected to the bottom of the micromachined silicon die 12 by anodic, glass or other hermetic bonding 24. This creates a sealed volume 26 of a gas, such as air, or a vacuum.

The pressure indicated by arrow 28 is provided by fluid impinging on the top surface of the diaphragm 14. The force created by the fluid pressure causes the diaphragm 14 to flex. As the diaphragm 14 flexes, the strain gauges 16 flex, thereby changing the resistance of the strain gauges 16. This resistance change is then translated into a pressure change by the electronics connected to the wirebond pads 20. The air or vacuum of the constant volume 26 trapped on the non sensed-fluid side of the diaphragm 14 creates a constant reference for the absolute sensor 10.

One of the drawbacks to this design is that the wirebond pads 20 are exposed to the sensed fluid. Since many sensed fluids are corrosive, the wirebond pads are destroyed over time. Another drawback of the standard design is that the electronics must also be in contact with the sensed fluid. These electronics are used to turn the strain gauge resistance changes with respect to pressure into a usable pressure output. The corrosive sensed fluid effects that degrade the wirebonds over time also degrade many electronic components and electronic substrates.

Another drawback of typical absolute silicon pressure sensors is that such sensors are not typically presented to the customer in a ready-to-use fashion. In other words, further sealing of the silicon die 12 over the resistive or piezoresistive strain gauges 16 and the conductive traces 18 and wirebonds pad 20 is often performed. A grease or other coating is deposited over the strain gauges 16, conductive traces 18, wirebond pads 20 and a cover, with an aperature admitting the sensed fluid, is attached to the hermetic material 22. While the grease provides some measure of protection for the electronic components, it does not fully isolate and protect the electronic components from the fluid over time. Also, the end user must perform troublesome and difficult attachment tasks to prepare the sensor for use.

### SUMMARY OF THE INVENTION

There is a need for an absolute micromachined silicon pressure sensor that protects the strain gauges, wirebonds, electronics, and electronic substrate from coming into contact with the sensed fluid, also providing a sensor that is ready-to-use as an absolute silicon pressure sensor.

These and other needs are met by embodiments of the present invention which provide an absolute pressure sensor comprising a die with a top and a bottom, and a diaphragm with a first side and a second side. The bottom and the first side form a fluid pressure side for exposure to a fluid. The top and the second side form a sensing side for sensing fluid on the first side of the diaphragm. A strain gauge and electrical connection are on the top side of the die and are isolated from exposure to the fluid.

The earlier stated needs are also met by other embodiments of the present invention, which provide an absolute micromachined silicon pressure sensor comprising a micromachined silicon die, having a planar top surface, and a bottom surface with a planar portion and a fluid pressure portion extending from the bottom surface to a first side of a diaphragm of the silicon die. The diaphragm also has a second side that is formed by the planar top surface. Strain gauges on the second side of the diaphragm, and wirebonds are located on the planar top surface. Conductive traces are also on the planar top surface, and connect the strain gauges to the wirebond pads. A backside hermetic cover is hermetically sealingly mounted on the planar top side surface of the silicon die and surrounds the second side of the diaphragm. The backside hermetic cover encloses a volume containing a vacuum or a sealed volume of gas. The backside hermetic cover is made of a hermetic material. All of the fluid whose pressure is to be sensed contacts the bottom surface and the fluid pressure portion of the silicon die. The planar top surface, the strain gauge, the wirebond pads and the conductive wire traces are isolated from exposure to the fluid.

The foregoing and other features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross-sectional view of an absolute micromachined silicon pressures sensor constructed in accordance with the prior art.

FIG. 2 is a schematic cross-sectional view of an absolute micromachined silicon pressure sensor constructed in accordance with embodiments of the present invention.

FIG. 3 is a schematic top view of the pressure sensor of FIG. 2 in accordance with embodiments of the present invention.

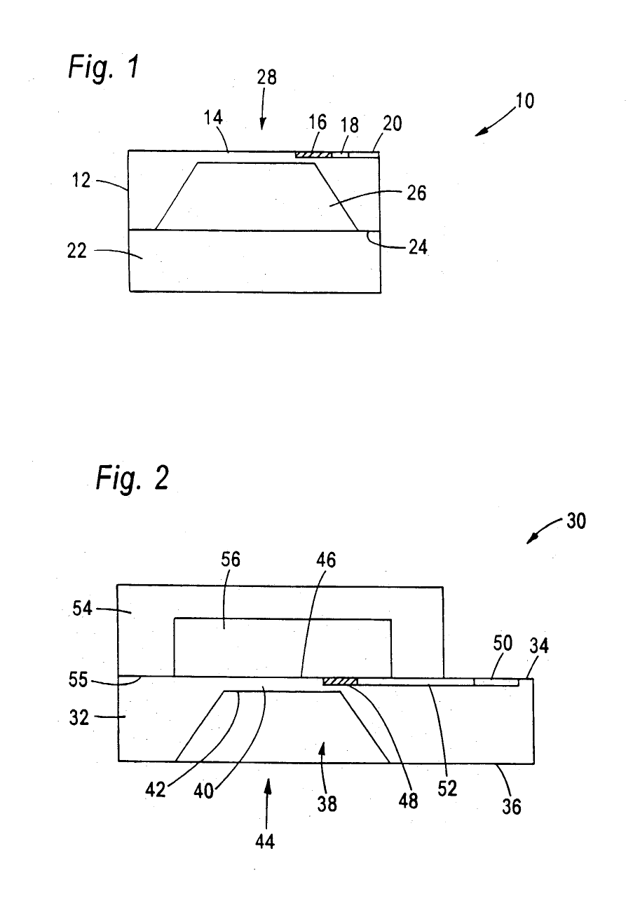

### DETAILED DESCRIPTION OF THE INVENTION

The present invention addresses and solves problems related to the formation of an absolute micromachined silicon pressure sensor, including exposure of the electronics to the corrosive effects of the fluid to be sensed, and the preparation of a ready-to-use sensor. This is achieved, in part, by providing the resistive or piezoresistive strain gauges, conductive traces, wirebond pads and other electronic components on a side of the micromachined silicon die that is isolated from exposure to the sensed fluid. Further, a hermetic cover is located on the backside, or top surface of the micromachined silicon die, that is isolated away from the sensed fluid pressure. The hermetic cover is directly bonded to the micromachined silicon die and encloses a sealed volume of gas or vacuum to produce the absolute pressure sensor. The direct bonding of the hermetic cover to the silicon die produces a ready-to-use pressure sensor such that further protection of the electronic components, and further sealing, is not required.

The pressure sensor 30 of the present invention is depicted in FIG. 2 and includes a micromachined silicon die 32 that may be, for example, on the order of 2×2.5 mm, though slightly enlarged in comparison to the prior art sensor, as depicted in FIG. 2. However, the indicated size of the micromachined silicon die is exemplary only, as the invention is not limited to this size or shape of device. The silicon die 32 has a top planar surface 34 and a bottom surface 36. The silicon die 32 has been machined to create a fluid pressure portion 38 that extends to the bottom surface 36 to a diaphragm 40. The thickness of the diaphragm 40 is between about 0.01 mm to about 0.20 mm, although other thicknesses are employed in other embodiments of the present invention, depending on the application. In certain embodiments of the invention, such as for a 14.7 psi pressure sensor, the diaphragm thickness is approximately 0.019 mm. Other thicknesses may be employed without departing from the scope of the invention.

The diaphragm 40 has a first side 42 that is exposed to the sensed fluid pressure (indicated by arrow 44), and a second side 46 that is on the top planar surface 34 of the silicon die 32. Also implanted on the top planar surface 34 or within the silicon die 32 is one or more resistive or piezoresistive strain gauges 48 which are connected to wirebond pads 50 by conductive traces 52.

Also attached to the top planar surface 34 is a backside hermetic cover 54, made of ceramic, glass or other hermetic material known to those of ordinary skill in the art. The hermetic cover 54 encloses a sealed volume 56 of gas or vacuum. The gas can be an inert gas, such as nitrogen, or air, etc. The hermetic cover 54 is directly bonded to the silicon die 32 in a hermetic fashion to form a hermetic bond 55. Examples of hermetic bonds include anodic bonds, eutectic bonds, and glass bonds, although other hermetic bonds can be used without departing from the invention. Anodic bonding is known to those of ordinary skill in the art and involves a high voltage application passed through the components to bond the cover 54 to the planar top surface 34 of the silicon die 32. In glass bonding, a glass interposer (not shown) is provided between the cover 54 and silicon die 32 and high temperature is applied to bond the cover 54 to the silicon die 32.

In operation, the piezoresistive or normally resistive strain gauges 48 will change resistance in the presence of diaphragm flex. The diaphragm 40 is flexed in the presence of sensed fluid pressure. The change in the resistance of strain gauges 48 can be directly translated by means of electronics into the pressure of the sensed fluid. The resistance values of the diaphragm 40 are presented to the electronics through the wirebond pads 50 via the conductive traces 52. The wirebond pads 50 are located outside the backside hermetic cover 54. This placement of the wirebond pads 50 allows easy wirebond electrical connections to the processing electronics.

The backside hermetic cover 54 entraps a constant volume of air or vacuum on the non-sensed fluid side of the micromachined diaphragm 40. The backside hermetic cover 54 presents a diaphragm 40 with the same volume of air or vacuum over the life of the product. This attachment is what allows the sensor to be an absolute sensor. Hence, the sensed fluid diaphragm 40 acts against a constant volume of air or vacuum rendering this sensor an absolute sensor.

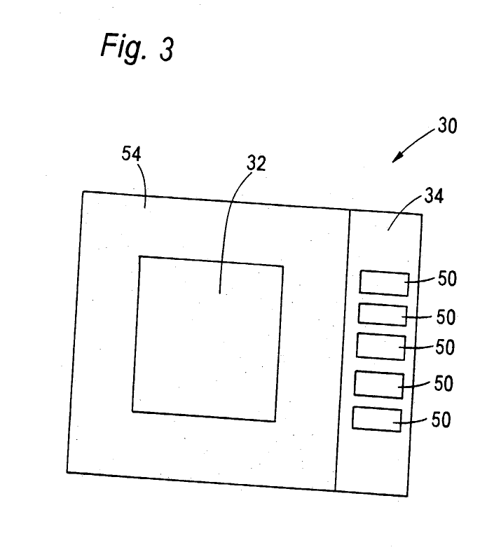

FIG. 3 is a top view of the pressure sensor 30 in accordance with embodiments of the present invention. The backside hermetic cover 54 is depicted as positioned over the silicon die 32, and is mounted on the top planar surface 34. The die 32 can be seen through the cover 54 in certain embodiments of the invention. The wire bond pads 50 are not covered by the backside hermetic cover 54 in preferred embodiments to allow easy electrical connection to the processing electronics.

The providing of the backside hermetic cover 54 directly to the silicon die 32 produces an absolute micromachined silicon pressure sensor that is ready-to-use, without further cover attaching needed. Also, the provision of the strain gauges, conductive traces and wirebond pads on the top surface of the silicon die, isolated from the sensed fluid pressure, prevents the damage to these components caused by the corrosive fluid. This extends the life of the pressure sensor of the present invention in comparison with sensor of the prior art.

Although the present invention has been described and illustrated in detail, it is to be clearly understood that the same is by way of illustration and example only and is not to be taken by of limitation, the scope of the present invention being limited only by the terms of the appended claims.

What is claimed is:

1. An absolute pressure sensor comprising:
a die with a top and a bottom, and a diaphragm with a first side and a second side, the bottom and the first side forming a fluid pressure side for exposure to a fluid, the top and the second side forming a sensing side for sensing fluid pressure on the first side of the diaphragm; and
at least one strain gauge and electrical connections on the top of the die and isolated from exposure to the fluid.

2. The sensor of claim 1, further comprising a hermetic cover attached to the top of the die.

3. The sensor of claim 2, wherein the hermetic cover is hermetically sealingly mounted on the top of the die.

4. The sensor of claim 3, wherein the hermetic cover encloses a volume and contains a substantial vacuum.

5. The sensor of claim 4, wherein the hermetic cover further encloses the at least one strain gauge.

6. The sensor of claim 3, wherein the hermetic cover encloses a volume and contains an inert gas.

7. The sensor of claim 6, wherein the hermetic cover further encloses the at least one strain gauge.

8. An absolute micromachined silicon pressure sensor, comprising:
a micromachined silicon die, having a planar top surface, and a bottom surface with a planar portion and a fluid pressure portion extending from the planar portion to a first side of a diaphragm of the silicon die, the diaphragm having a second side formed by the planar top surface;
at least one strain gauge on the second side of the diaphragm;
wirebond pads on the planar top surface;
conductive traces on the planar top surface, connecting the at least one strain gauge to the wirebond pads; and
a backside hermetic cover hermetically sealingly mounted on the planar top surface of the silicon die and surrounding the second side of the diaphragm, the backside hermetic cover enclosing a volume containing a vacuum or a sealed volume of gas, the backside hermetic cover being made of hermetic material;
wherein all fluid whose pressure is to be sensed contacts the bottom surface and the fluid pressure portion of the silicon die, with the planar top surface, the at least one strain gauge, the wirebond pads and the conductive traces being isolated from exposure to the fluid.

9. A pressure sensor comprising:
a silicon die with a diaphragm;
a hermetic cover attached to the silicon die and enclosing a volume; and
at least one strain gauge on the silicon die measuring deflection of the diaphragm and enclosed within the volume.

10. The sensor of claim 9, wherein the diaphragm has a first side and a second side, the first side forming a fluid pressure side for exposure to a fluid, the second side forming a sensing side for sensing fluid pressure on the first side of the diaphragm.

11. The sensor of claim 10, wherein the at least one strain gauge and the hermetic cover are mounted on the second side of the diaphragm.

12. The sensor of claim 11, further comprising electrical connections and wirebonds mounted on the silicon die on the same side of the silicon die as the at least one strain gauge.

13. The sensor of claim 12, wherein the volume enclosed by the hermetic cover contains a vacuum.

14. The sensor of claim 12, wherein the volume enclosed by the hermetic cover contains a sealed volume of gas.
